(19) United States
(12) Patent Application Publication
(10) Pub. No.: US 2022/0355720 A1
(43) Pub. Date: Nov. 10, 2022

(54) CONNECTED MODULAR CAMPER TRAILER SYSTEMS AND METHODS

(71) Applicant: Honda Motor Co., Ltd., Tokyo (JP)

(72) Inventors: Dillon KANE, Los Angeles, CA (US); Jonathan MOSS, Los Angeles, CA (US); Shinngaram CHOI, Los Angeles, CA (US); Kyle HARP, Cable, OH (US); Matthew STAAL, Torrance, CA (US); Scott BALDWIN, Torrance, CA (US); Lili MELIKIAN, Sun Valley, CA (US); Victor ACUNA, San Pedro, CA (US)

(21) Appl. No.: 17/705,486

(22) Filed: Mar. 28, 2022

Related U.S. Application Data
(60) Provisional application No. 63/184,762, filed on May 5, 2021.
(60) Provisional application No. 63/218,823, filed on Jul. 6, 2021.

(51) Int. Cl. B60P 3/34; B60P 3/36

(52) U.S. Cl. CPC B60P 3/34; B60P 3/36

(57) ABSTRACT

A portable dwelling system includes a rigid dwelling, an external frame, and a plurality of modular amenity units. The rigid dwelling is capable of being removably mountable to a trailer. The external frame is coupled to an exterior of the rigid dwelling and includes an integrated powered rail electrically connected to a power source. The external frame defines receiving areas having a standard size on the exterior of the rigid dwelling. The plurality of modular amenity units each removably interchangeable at any one of the receiving areas via a connector configuration. The connector configuration electrically couples the powered rail to each of the plurality of modular amenity units.

### RELATED APPLICATIONS

This application claims priority to U.S. Prov. Application Ser. No. 63/184762 filed on May 5, 2021, which is expressly incorporated herein by reference. This application also claims priority to U.S. Prov. Application Ser. No. 63/218823 filed Jul. 6, 2021, which is also expressly incorporated herein by reference.

### BACKGROUND

Recently, camping has become an increasingly popular outdoor activity and travel option due to travel habits of the next generation and the pandemic. This surge in popularity has led to an increase in demand for recreational vehicles (RVs) (e.g., campers, camper van). Unfortunately, the RV industry has struggled to innovate in technology and design. In fact, RVs have not changed significantly over the last few decades. For example, campers may either be towed as a standalone unit or may be driven as a camper van. These configurations are not space or energy efficient and cannot provide the amenities and flexibility necessary for today's consumers. The modular camper trailer systems and methods thereof overcome these challenges. Further advantages will be discussed herein.

### BRIEF DESCRIPTION

According to one aspect, a portable dwelling system includes a rigid dwelling, an external frame, and a plurality of modular amenity units. The rigid dwelling is capable of being removably mountable to a trailer. The external frame is coupled to an exterior of the rigid dwelling and includes an integrated powered rail electrically connected to a power source. The external frame defines receiving areas having a standard size on the exterior of the rigid dwelling. The plurality of modular amenity units each removably interchangeable at any one of the receiving areas via a connector configuration. The connector configuration electrically couples the powered rail to each of the plurality of modular amenity units.

According to another aspect, a portable dwelling includes a rigid enclosure including a top portion, a bottom portion, and side wall portions. The portable dwelling also includes an external frame coupled to the rigid enclosure. The external frame defines receiving areas on at least one of the top portion, the bottom portion, and the side wall portions of the rigid enclosure in which modular amenity units may be received. The portable dwelling also includes a powered rail integrated with the external frame and electrically connected to a power source. The portable dwelling further includes a connector for physically and electrically coupling the modular amenity units with the external frame and the powered rail at the receiving areas.

According to a further aspect, a powered modular dwelling frame includes an external frame configured to be coupled to a rigid enclosure. The external frame includes frame members that define a plurality of receiving areas with respect to the rigid enclosure for receiving modular amenity units. Further, the powered modular dwelling frame includes a powered rail integrated with the external frame and electrically connected to a power source for providing power to the modular amenity units. The powered modular dwelling frame also includes a connector configuration for physically and electrically coupling the modular amenity units at the plurality of receiving areas.

### BRIEF DESCRIPTION OF THE DRAWINGS

The accompanying drawings, which are incorporated in and constitute a part of the specification, illustrate various systems, methods, devices, and other embodiments of the disclosure. It will be appreciated that the illustrated element boundaries (e.g., boxes, groups of boxes, directional lines, or other shapes) in the figures represent one embodiment of the boundaries. In some embodiments, one element may be designed as multiple elements or that multiple elements may be designed as one element. In some embodiments, an element shown as an internal component of another element may be implemented as an external component and vice versa. Furthermore, elements may not be drawn to scale.

FIG. 1 is a perspective view of a portable dwelling system according to one exemplary embodiment;

FIG. 2 is a detailed perspective view of the dwelling of FIG. 1 according to one exemplary embodiment;

FIG. 3 is a schematic block diagram of a connector configuration according to an exemplary embodiment;

FIG. 4A is a perspective side view of a modular amenity unit and a receiving area of the dwelling;

FIG. 4B is perspective side view of engaging the modular amenity unit with the receiving area;

FIG. 4C is perspective side view of the modular amenity unit mounted to the receiving area

FIG. 5A is perspective view of an exemplary modular amenity unit, namely, a sink unit;

FIG. 5B is perspective view of an exemplary modular amenity unit, namely, a ladder unit;

FIG. 5C is perspective view of an exemplary modular amenity unit, namely, a refrigeration unit;

FIG. 6 is a flow chart of an exemplary method of controlling one or more components of the portable dwelling system according to an exemplary embodiment; and

FIG. 7 is a block diagram of an exemplary computing system according to one embodiment.

### DETAILED DESCRIPTION

The systems and methods discussed herein provide for a portable dwelling system (e.g., a camper system) including a portable dwelling configured with several amenities or features thereon or therein. As will be discussed in more detail herein, the portable dwelling may have a set or apertures, openings, and/or cavities for removably mountable and interchangeable module units. A quick-connect configuration allows for each module unit to physically and electrically interface with the portable dwelling. The modular configuration and connector configuration provide efficient use of space as well as desired amenities for today's consumers.

### I. SYSTEM OVERVIEW

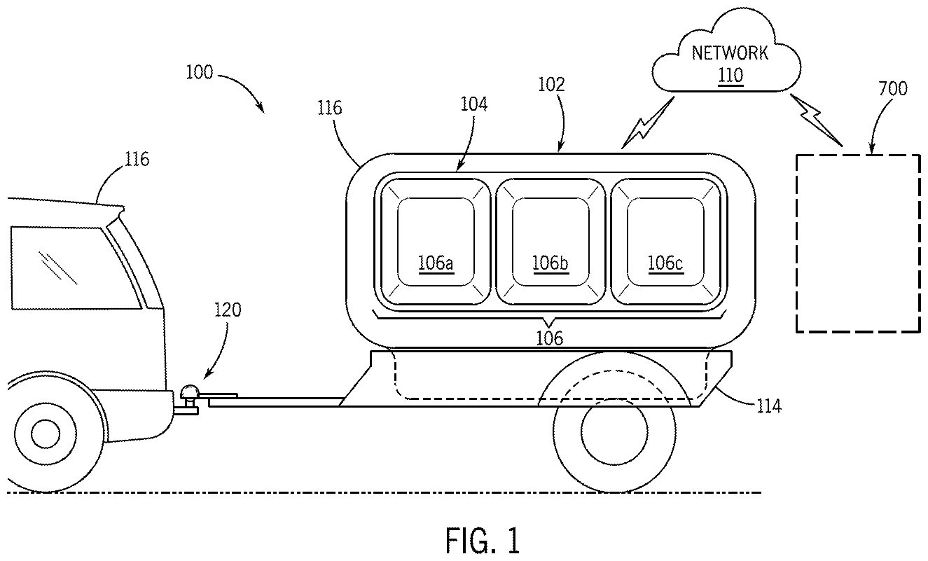

Referring now to the drawings, wherein the showings are for purposes of illustrating one or more exemplary embodiments and not for purposes of limiting same, FIG. 1 is a schematic diagram of a portable dwelling system 100 according to one exemplary embodiment. The portable dwelling system 100 and components discussed herein are illustrative only and it is understood that one or more of the components may be omitted and/or arranged in different configurations than that shown in FIG. 1. In FIG. 1, the portable dwelling system 100 includes a dwelling 102, a frame 104, and a plurality of modular amenity units 106. As will be discussed in more detail, one or more of the components of the portable dwelling system 100 is operatively connected for computer communication via a network 110.

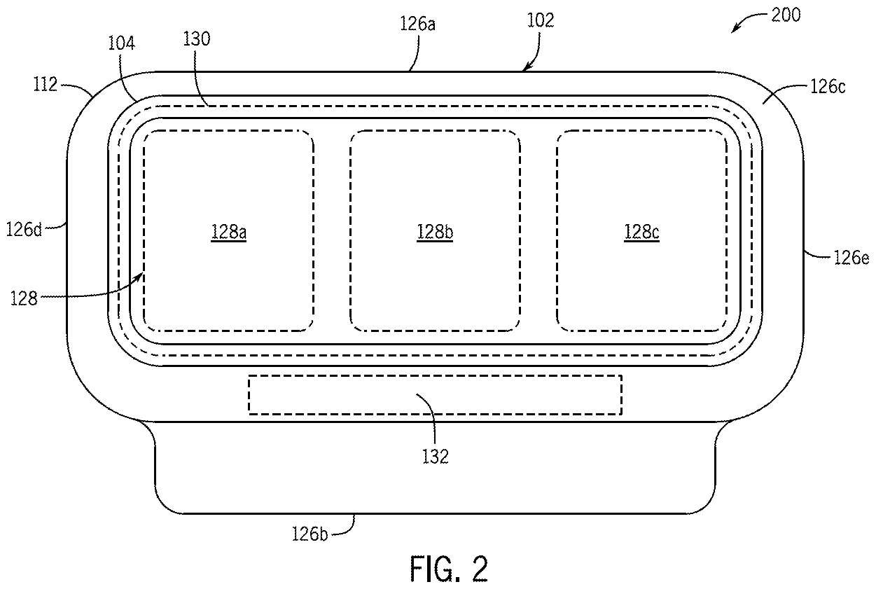

The dwelling 102 includes a rigid enclosure 112 that provides for a self-contained portable housing and/or living space (e.g., a cabin). Accordingly, the dwelling 102 generally comprises a roof, four external walls, and a base. As shown in FIG. 2, the rigid enclosure 112 includes a top portion 126a, a bottom portion 126b, a side wall portion 126c, a first end portion 126d, and a second end portion 126e. The dwelling 102 and/or the rigid enclosure 112 may be composed of fiberglass, composite materials, aluminum, among other rigid materials. The interior (not shown) of the dwelling 102 and/or the rigid enclosure 112 provides room for a living space and may include, for example, a sleeping quarters with a bed. Additional living objects and/or quarters may be enclosed within the dwelling 102. For example, a portable toilet, seating, kitchen unit, mud room, among others.

In some embodiments, the dwelling 102 is referred to as a camper than may be placed and/or secured atop a transportable base to transport the dwelling 102. Referring again to FIG. 1, the dwelling 102 is capable of being removably mountable to a trailer 114. As shown in FIG. 1, the dwelling 102 is placed on a distal portion and/or distal end of the trailer 114. The trailer 114 may be construed of sturdy materials such as steel, wood, composite materials, and the like. The trailer 114 may include two or more wheels that allow for the trailer to be pulled. In one example, four wheels may be used and placed on a distal portion of the trailer 114.

The dwelling 102 may be secured or tied to the trailer 114 through dedicated fasteners (not shown). Securing mechanisms may include bolts, screws, nuts, hinges, slots, inserts, and the like. For example, the dwelling 102 may include male and/or female connectors such that a secure connection may be made between the dwelling 102 and the trailer 114.

In some embodiments, and as shown in FIG. 1, the trailer 114 is capable of being interconnected with a vehicle 116 via a hitch configuration 120. Thus, the trailer 114 is capable of being towed by the vehicle 116. It is understood that the trailer 114 and/or the hitch configuration 120 may be configured in different shapes and sizes than that shown in FIG. 1. For example, the configuration of the trailer 114 and/or the hitch configuration may be dependent on characteristics (e.g., type, weight, class) of the dwelling 102, the trailer 114, and/or the vehicle 116. Additional wirings or conduits may be provided between the dwelling 102, the trailer 114, and/or the vehicle 116. These wirings or conduits may communicate signals or other information between the dwelling 102, the trailer 114, and/or the vehicle 116. For example, information about the vehicle 116 and operations of the vehicle 116 may be communicated to the trailer 114. As will be discussed herein, these signals or other information may be communicated wirelessly using the network 110. In some embodiments, these conduits may also provide fuel, water, or the like from the vehicle 116 or to the vehicle 116. In one example, the wiring may provide power from a battery (not shown) within the vehicle 116 to the dwelling 102.

Although not shown in FIG. 1, the dwelling 102 may include a plurality of stands that allow the dwelling 102 to be supported independently. When the dwelling 102 is coupled to the trailer, the plurality of stands allows the dwelling to be removed from the trailer 114. The stands may be made of metal, alloy, and the like. The stands provide proper support and may be tied into the ground. Dedicated connecting portions on the exterior of the dwelling 102 may be used to lock the stands into place. The stands may be fastened into the connecting portions through bolts, screws, nuts, hinges, slots, inserts, or similar mechanism. In one embodiment, four or more stands may be implanted to support the dwelling 102. In one illustrative example, the stands are placed on the dwelling 102 and the trailer 114 may then be removed. The dwelling 102 may be raised through the stands, like how a car jack lifts a vehicle.

Advantageously, and by removing the trailer 114, the trailer 114 may be used to haul other recreational devices such as jet skis, ATVs, and the like. For example, when lowering jet skis into a lake, the trailer 114 may be used with the jet skis being stored in a front portion while being transported and then switched to a back portion when lowered into the lake. Separating the dwelling 102 from the trailer 114 also allows the dwelling 102 to connect other lines and/or piping such as a water, waste, or electric lines.

Referring again to FIG. 1, the frame 104 may be referred to herein as an external frame and/or a powered modular dwelling frame. The frame 104 is coupled to an exterior of the dwelling 102. In some embodiments, the frame 104 includes multiple frame members defining receiving areas. More specifically, in FIG. 1, the frame 104 defines a receiving area 128 having a standard size on the exterior of the dwelling 102. This standard sizing allows each of the modular amenity units 106 to be interchanged within the receiving area 128. The modular amenity units 106 may face outwards or may go inwards to reduce drag while the dwelling 102 is traveling. As such, the modular amenity units 106 may take room within the interior of the dwelling 102 body.

In one embodiment, the external frame defines the receiving area 128 on at least one of the top portion 126a, the bottom portion 126b, the side wall portion 126c, the first end portion 126d, and/or the second end portion 126e. The receiving area 128 are for receiving one or more of the plurality of modular amenity units 106. Each of the plurality of receiving areas 128 is configured to engage with any one of the modular amenity units 106 (e.g., via a connector configuration).

The receiving area 128 in FIG. 1 illustrates one configuration of how the modular amenity units may fit into the frame 104 of the dwelling 102. In this embodiment, the frame 104 defines the receiving area 128 as a window space with three windows on the side wall portion 126c. Here, the receiving area 128 includes a receiving area defined by each of the three windows, namely, a first receiving area 128a, a second receiving area 128b, and a third receiving area 128c. In this embodiment, each window may provide additional structural components for properly securing the modular amenity units 106 into place.

As shown in FIG. 2, the frame 104 includes a powered rail 130 integrated with the frame 104. The powered rail 130 is electrically connected to a power source 132 and acts a conduit to provide energy from the power source 132 to one or more of the modular amenity units 106. In some embodiments, the powered rail 130 may be a duct, line, pipe, wire, or other device and its accessories used to produce, store, transmit, or distribute a utility service. A utility service may include communications, data, electricity, heat, natural or manufactured gas, oil, petroleum products, steam, sewage, water, among others.

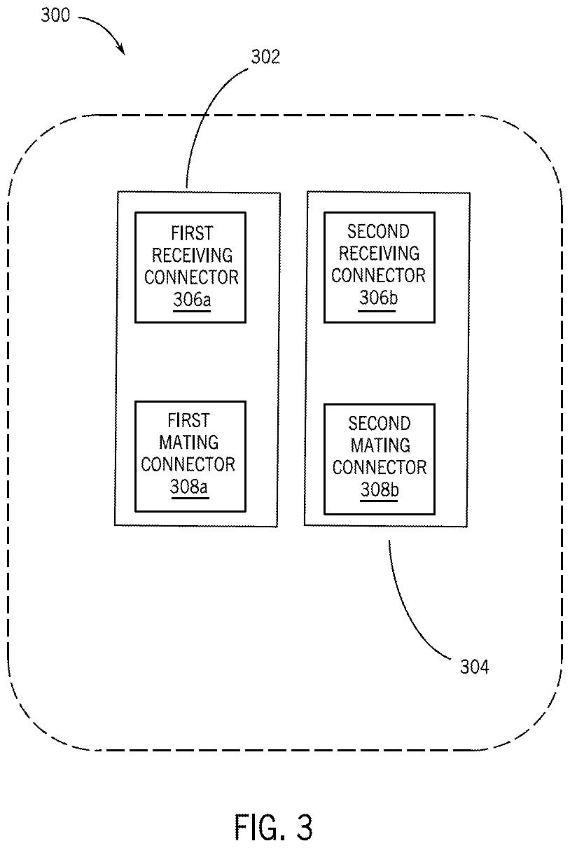

As will be discussed in more detail herein with FIG. 3, a connector configuration including locks, latches, or other fastening systems may be used to secure the plurality of modular amenity units 106 to the dwelling 102 and provide power to the plurality of modular amenity units 106 from the powered rail 130 (e.g., via the power source 132). Accordingly, the frame 104 and the powered rail 130 advantageously provide a physical and electrical interface for the plurality of modular amenity units 106 that is functional and space saving.

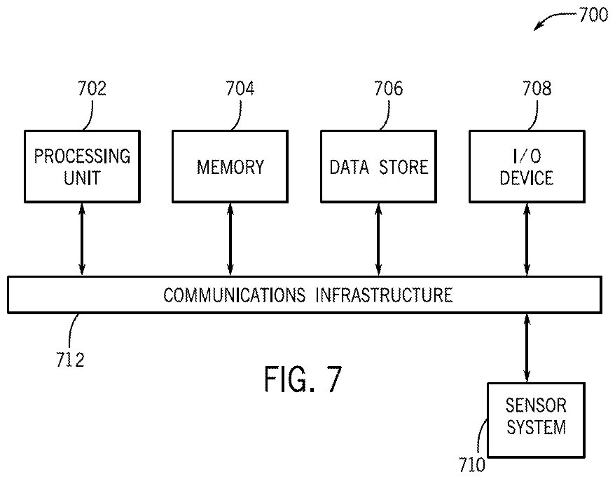

Referring again to FIG. 1, the portable dwelling system 100 also includes a computing system 700 for facilitating functions and control of one or more components of the portable dwelling system 100. As will be described in further detail with FIG. 7, one or more of the components of the portable dwelling system 100 may include and/or may be executed by one or more components of the computing system 700. Accordingly, although the computing system 700 is shown as a stand-alone computing component in FIG. 1, it is understood that one or more components of the computing system 700 may be integrated with the dwelling 102, the plurality of modular amenity units 106, the trailer 114, and/or the vehicle 116. For example, in some embodiments, each of the plurality of modular amenity units 106 includes a processor and are operatively connected for computer communication with other connected components of the portable dwelling system 100 via the network 110.

### II. CONNECTOR CONFIGURATION

Referring now to FIG. 3 with further reference to the components of FIGS. 1 and 2, a connector configuration 300 for coupling the modular amenity units 106 with the dwelling 102 will be described. As mentioned above, the connector configuration 300 provides a seamless mechanical and electrical connection between the modular amenity units 106 and the dwelling 102. Generally, the connector configuration 300 may include locks, latches, couplings, or other fastening systems, that use a single motion to attach and detach the modular amenity unit 106 to the dwelling 102. More specifically, the connector configuration provides a physical connection between the modular amenity unit 106 and the dwelling 102 at the frame 108 and/or the receiving area 128, and an electrical connection between the modular amenity unit 106 and the powered rail 130. Thus, not only does the connector configuration 300 secure the modular amenity unit 106, but it also enables the powered rail 130 to distribute power from the power source 132.

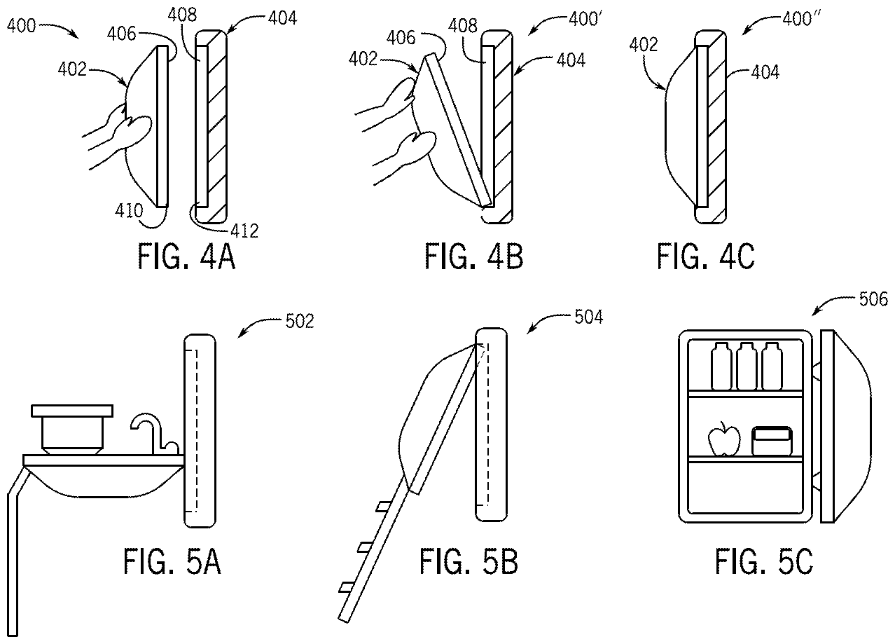

In FIG. 3, the connector configuration 300 includes a first connector 302 which may be referred to as a receiving connector. In one embodiment, the receiving connector is positioned at a selectable location on the frame 104 and coupled to the powered rail 130. The connector configuration 300 also includes a second connector 304 which may be referred to as a mating connector. In one embodiment, the mating connector is positioned at a selectable location on each of the modular amenity units 106. The first connector 302 is configured to engage with the mating connector 304 thereby physically attaching each of the modular amenity units 106 to the dwelling 102 (e.g., the frame 104) and electrically coupling the each of the modular amenity units 106 with the powered rail 130. As will be discussed in more detail with FIGS. 4A-4C, the first connector 302 and the second connector 304 are configured to be aligned and coupled to secure the modular amenity unit 106 to the dwelling 102.

In another embodiment, the first connector 302 is for mechanically coupling the modular amenity units 106 to the dwelling 102, and the second connector 304 is for electrically coupling the modular amenity units 106 to the powered rail 130. More specifically, in FIG. 3, the first connector 302 may include a first receiving connector 306a and a first mating connector 308a. The first receiving connector 306a may be positioned at a selectable location on the dwelling 102 and/or the frame 104. The first mating connector 308a may be positioned at a selectable location on the modular amenity unit 106. Further, the second connector 304 includes a second receiving connector 308a and a second mating connector 308b. The second receiving connector 306b may be positioned at a selectable location on the powered rail 130. The second mating connector 308b may be positioned at a selectable location on the modular amenity unit 106. In this embodiment, the first receiving connector 306a and the first mating connector 308a are configured to be aligned and coupled to mechanically secure the modular amenity unit 106 to the dwelling 102. The second receiving connector 306b and the second mating connector 308b are configured to be aligned and coupled to electrically connect the modular amenity unit 106 to the dwelling 102.

An illustrative example of coupling the modular amenity unit 106 to the dwelling 108 will now be described with reference to FIGS. 4A, 4B, and 4C. FIG. 4A a perspective side view 400 of a modular amenity unit 402 and a dwelling 404. For simplicity, in FIGS. 4A, 4B, and 4C, a partial side view of the dwelling 404 is shown. The modular amenity unit 402 has a receiving side 406. The dwelling 404 has a receiving area 408 for receiving and coupling with the modular amenity unit 402. The modular amenity unit 402 also has a mating connector 410 at an end portion of the modular amenity unit 402 on the receiving side 406. A corresponding receiving connector 412 is positioned on an end portion of the receiving area 408. It is understood that the positions of the mating connector 410 and the receiving connector 412 are for exemplary purposes only and that these components may be in other positions.

In FIG. 4A, the modular amenity unit 402 is aligned with the receiving area 408 (e.g., corresponding recess) with the receiving side 406 facing the receiving area 408. More specifically, in the perspective view 400′ in FIG. 4B the mating connector 410 is aligned with the receiving connector 412 and the modular amenity unit 402 is inserted into the receiving area 408. As shown in the perspective view 400″ of FIG. 4C, the modular amenity unit 402 is received by the receiving area 408 so that the receiving side 406 is flush against the receiving area 408 thereby physically attaching the modular amenity unit 402 to the dwelling and electrically coupling the modular amenity unit 402 with the powered rail 130 (not shown). The insertion shown in FIG. 4B and the positioning of the modular amenity unit 402 shown in FIG. 4C provides for a quick-connect with a single motion to attach the modular amenity unit 402 to the dwelling 404.

### III. EXEMPLARY MODULAR AMENITY UNITS

Generally, the modular amenity units may be used for storing or providing a service and/or amenity to a user and/or a dwelling. In some embodiments, other modular amenity units may include energy sources for the dwelling. In one embodiment, the modular amenity units are selected from a kitchen unit, a bathroom unit, a laundry unit, a cooling unit, a storage unit, and a charging unit. Referring now to FIGS. 5A, 5B, and 5C, illustrative examples of modular amenity units in a deployed position are shown. Specifically, FIG. 5A is an illustrative example of a sink modular amenity unit 502, FIG. 5B is an illustrative example of a ladder modular amenity unity 504, and FIG. 5C is an illustrative example of a refrigerator modular amenity unity 506. Other types of modular amenity units may also be contemplated with the systems and methods described herein.

As discussed above, the modular amenity units 106 may be configured as shown in FIG. 1. Each of the modular amenity units 106 may be adjusted through additions or removals based on the type of the vehicle 116. For example, a vehicle that is pulling the dwelling 102 may be limited to pulling 3200 lbs., while other vehicles may pull 1800 pounds and/or 2500 pounds. The modular amenity units 106 may be used with different vehicles based on their pulling power, that is, modular amenity units 106 may be removed or added, and various modular amenity units 106 may be used.

Each modular amenity unit 106 and/or configuration of modular amenity units 106 may have its own weight. In some embodiments, one or more of the modular amenity units 106 contain fuel, water, and the like. Through the different configurations, methods and functions that will be described in more detail herein with the computing system 700 may be used to determine how much weight was added through the modular amenity units 106. The computing system 700 may automatically calculate the entirety of the weight based on the interior objects such as the bedding and structure, and then add the weight from the modular amenity units 106. In one alternative, a sensor (e.g., FIG. 7, the sensor system 710) on the bottom of the dwelling 102 may be used to determine the exact weight measurement of the dwelling 102. This information may be communicated to one or more components of the portable dwelling system 100 using, for example, the network 110.

Through these calculations, an appropriate vehicle for pulling the weight may be determined and communicated to a user. For example, transmitted and/or displayed to a portable device. Different configurations of the modular amenity units 106 may also be used before a user places the modular amenity units 106 onto the dwelling 102. A graphical user interface (GUI) of the computing system 700 may be part of the application facilitating these types of calculations. Fuel, water, gas, and or other types of information may be communicated and/or displayed such that a user may be aware of whether they have to fill up or replenish the dwelling 102. In some embodiments, warnings may be given if levels drop below a certain threshold value. Communication and control of one or more components of the portable dwelling system 100 will now be described in more detail.

### VI. PORTABLE DWELLING SYSTEM METHODS

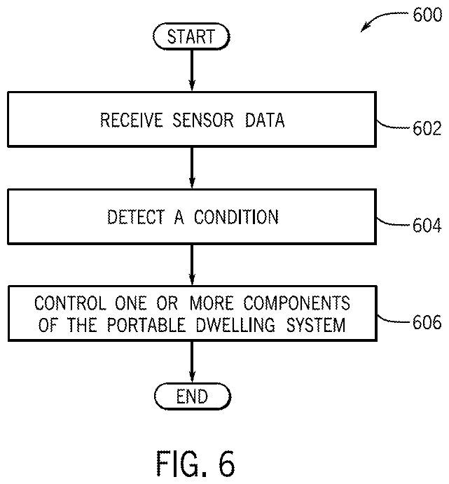

Referring now to FIG. 6, a flow chart of a method 600 for communication and control of one or more components of the portable dwelling system 100 of FIG. 1 is shown. It is understood that one or more of the functions described herein may be executed and/or facilitated by one or more components of the portable dwelling system 100. In particular, the computing system 700 described in detail with FIG. 7 may be used to implement and/or execute the methods, functions, and components described herein.

At block 602, the method 600 includes receiving sensor data. For example, sensor data about one or more of the components of the portable dwelling system 100 may be sensed and/or retrieved from the sensor system 710. Sensor data may be communicated between components using, for example, the network 110. In one illustrative example, a load sensor (not shown) is positioned in the bottom of the dwelling 102. Weight data about the dwelling 102 may be gathered by the load sensor. In another example, load sensors (not shown) are positioned in each of the modular amenity units 106. Weight data about each of the modular amenity units 106 may be gathered by the load sensors.

At block 604, the method 600 includes detecting a condition based on the sensor data. The condition may be a predefined threshold and/or criteria about any one of the components of the portable dwelling system 100. For example, the weight data about the dwelling 102 and/or the modular amenity units 106 may be compared to a predefined threshold to determine vehicle types that are capable of transporting the dwelling 102.

At block 606, the method 600 includes controlling one or more components of the portable dwelling system 100. For example, the computing system 700 may control a display and/or transmit information about an appropriate vehicle for pulling the dwelling based on the weight characteristics determined at block 604.

### V. SYSTEM CONFIGURATION AND DEFINITIONS

As mentioned above, the computing system 700 may be used to implement and/or execute the methods, functions, and components described herein. In FIG. 7, the computing system 700 includes a processing unit 702, a memory 704, a data store 706, an I/O device 708, and a sensor system 710 each operatively connected for computer communication to a communications infrastructure 712.

The processing unit 702 may include logic circuitry with hardware, firmware, and software architecture frameworks for facilitating the methods, functions, and components as described herein. In some embodiments, the processing unit 702 may store application frameworks, kernels, libraries, drivers, application program interfaces, among others, to execute and control hardware and functions discussed herein. In some embodiments, the memory 704 and/or the data store 706 may store similar components as the processing unit 702 for execution by the processing unit 702. The I/O device 708 may include one or more input-output devices for providing visual, audio, and/or tactile input and/or output from and/or to another entity (e.g., an operator on a manufacturing line). The I/O device 708 may be a monitor, display, keyboards, touch screens, speakers, among other devices.

Generally, the sensor system 710 may include various types of sensors for use with any component of the portable dwelling system 100 for detecting and/or sensing a parameter of the dwelling 102, the frame 14, the modular amenity units 106, the trailer 114, the vehicle 116, and/or the environment surrounding any one of the components of the portable dwelling system 100. In particular, the sensor system 710 may include, but is not limited to: acceleration sensors, speed sensors, braking sensors, proximity sensors, vision sensors, ranging sensors, seat sensors, seat-belt sensors, door sensors, environmental sensors, yaw rate sensors, steering sensors, GPS sensors, among others. It is also understood that the sensor system 710 may include any type of sensor, for example, acoustic, electric, environmental, optical, imaging, light, pressure, force, thermal, temperature, proximity, among others.

The communications infrastructure 712 may include software and hardware to facilitate communication between the components of the computing system 700 and/or other components of the portable dwelling system 100. Specifically, the communications infrastructure 712 may include network interface controllers, other hardware and software that manages and/or monitors connections, and/or controls bi-directional data transfer using, for example, a communication network (e.g., the network 110).

The following includes definitions of selected terms employed herein. The definitions include numerous examples and/or forms of components that fall within the scope of a term and that may be used for implementation. The examples are not intended to be limiting. Further, the components discussed herein, may be combined, omitted or organized with other components or into different architectures.

“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Computer communication,” as used herein, refers to a communication between two or more computing devices (e.g., computer, personal digital assistant, cellular telephone, network device, vehicle, vehicle computing device, infrastructure device, roadside device) and may be, for example, a network transfer, a data transfer, a file transfer, an applet transfer, an email, a hypertext transfer protocol (HTTP) transfer, and so on. A computer communication may occur across any type of wired or wireless system and/or network having any type of configuration, for example, a local area network (LAN), a personal area network (PAN), a wireless personal area network (WPAN), a wireless area network (WAN), a wide area network (WAN), a metropolitan area network (MAN), a virtual private network (VPN), a cellular network, a token ring network, a point-to-point network, an ad hoc network, a mobile ad hoc network, a vehicular ad hoc network (VANET), a vehicle-to-vehicle (V2V) network, a vehicle-to-everything (V2X) network, a vehicle-to-infrastructure (V2I) network, among others. Computer communication may utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

“Computer-readable medium,” as used herein, refers to a non-transitory medium that stores instructions, algorithms, and/or data configured to perform one or more of the disclosed functions when executed. Computer-readable medium may be non-volatile, volatile, removable, and non-removable, media implemented in any method or technology for storage of information such as computer readable instructions, data structures, modules or other data. Computer-readable medium may include, but is not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device may interface with. Computer-readable medium excludes non-transitory tangible media and propagated data signals.

“Database,” as used herein, is used to refer to a table. In other examples, “database” may be used to refer to a set of tables. In still other examples, “database” may refer to a set of data stores and methods for accessing and/or manipulating those data stores. A database may be stored, for example, at a disk and/or a memory.

“Memory,” as used herein may include volatile memory and/or nonvolatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

“Operable connection,” or a connection by which entities are “operably connected,” is one in which signals, physical communications, and/or logical communications may be sent and/or received. An operable connection may include a wireless interface, a physical interface, a data interface, and/or an electrical interface.

“Processor,” as used herein, processes signals and performs general computing and arithmetic functions. Signals processed by the processor may include digital signals, data signals, computer instructions, processor instructions, messages, a bit, a bit stream, that may be received, transmitted and/or detected. Generally, the processor may be a variety of various processors including multiple single and multicore processors and co-processors and other multiple single and multicore processor and co-processor architectures. The processor may include logic circuitry to execute actions and/or algorithms.

“Vehicle,” as used herein, refers to any moving vehicle capable of carrying one or more human occupants and is powered by any form of energy. The term “vehicle” includes, but is not limited to cars, trucks, vans, minivans, SUVs, motorcycles, scooters, boats, go-karts, amusement ride cars, rail transport, personal watercraft, and aircraft. In some cases, a motor vehicle includes one or more engines. Further, the term “vehicle” may refer to an electric vehicle (EV) capable of carrying one or more human occupants and is powered entirely or partially by one or more electric motors powered by an electric battery. The EV may include battery electric vehicles (BEV) and plug-in hybrid electric vehicles (PHEV). The term “vehicle” may also refer to an autonomous vehicle and/or self-driving vehicle powered by any form of energy. The autonomous vehicle may carry one or more human occupants. The autonomous vehicle may have any level or mode of driving automation ranging from, for example, fully manual to fully autonomous. Further, the term “vehicle” may include vehicles that are automated or non-automated with pre-determined paths or free-moving vehicles.

It will be appreciated that various embodiments of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

The embodiments discussed herein may also be described and implemented in the context of “computer-readable medium” or “computer storage medium.” As used herein, “computer-readable medium” or “computer storage medium refers to a non-transitory medium that stores instructions, algorithms, and/or data configured to perform one or more of the disclosed functions when executed. Computer-readable medium may be non-volatile, volatile, removable, and non-removable, media implemented in any method or technology for storage of information such as computer readable instructions, data structures, modules or other data. Computer-readable medium may include, but is not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device may interface with. Computer-readable medium excludes non-transitory tangible media and propagated data signals.

It will be appreciated that various embodiments of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A portable dwelling system, comprising:
a rigid dwelling capable of being removably mountable to a trailer;
an external frame coupled to an exterior of the rigid dwelling and including an integrated powered rail electrically connected to a power source, wherein the external frame defines receiving areas having a standard size on the exterior of the rigid dwelling; and
a plurality of modular amenity units each removably interchangeable at any one of the receiving areas via a connector configuration, wherein the connector configuration electrically couples the powered rail to each of the plurality of modular amenity units.

2. The portable dwelling system of claim 1, wherein the connector configuration includes a receiving connector positioned at a selectable location on the external frame and coupled to the powered rail.

3. The portable dwelling system of claim 2, wherein the connector configuration includes a mating connector positioned at a selectable location on each of the modular amenity units.

4. The portable dwelling system of claim 3, wherein the receiving connector is configured to engage with the mating connector thereby physically attaching each of the modular amenity units to the rigid dwelling and electrically coupling the each of the modular amenity units with the powered rail.

5. The portable dwelling system of claim 3, wherein each of the modular amenity units are configured to be removably engaged with any one of the receiving areas by aligning the mating connector with the receiving connector and inserting a receiving side of each of the modular amenity units into a corresponding recess of the receiving areas thereby physically attaching each of the modular amenity units to the dwelling and electrically coupling the each of the modular amenity units with the powered rail.

6. The portable dwelling system of claim 1, wherein the trailer is capable of being interconnected with a vehicle.

7. The portable dwelling system of claim 1, wherein the modular amenity units are selected from a kitchen unit, a bathroom unit, a laundry unit, a cooling unit, a storage unit, and a charging unit.

8. The portable dwelling system of claim 1, further including a processor and a sensor system each communicatively coupled to each of the modular amenity units.

9. A portable dwelling, comprising:
a rigid enclosure including a top portion, a bottom portion, and side wall portions;
an external frame coupled to the rigid enclosure, wherein the external frame defines receiving areas on at least one of the top portion, the bottom portion, and the side wall portions of the rigid enclosure in which modular amenity units can be received;
a powered rail integrated with the external frame and electrically connected to a power source; and
a connector for physically and electrically coupling the modular amenity units with the external frame and the powered rail at the receiving areas.

10. The portable dwelling of claim 9, wherein the connector enables the powered rail to distribute power from the power source to the modular amenity units.

11. The portable dwelling of claim 9, wherein the connector includes a first connector for mechanically coupling the modular amenity units to the portable dwelling, and a second connector for electrically coupling the modular amenity units to the powered rail.

12. The portable dwelling of claim 9, wherein the external frame includes multiple frame members defining the receiving areas.

13. The portable dwelling of claim 9, wherein the receiving areas are a standard size allowing the modular amenity units to be interchanged within the receiving areas.

14. The portable dwelling of claim 9, wherein the portable dwelling is removably mountable to a trailer and the trailer is capable of being towed by a vehicle.

15. The portable dwelling of claim 9, further including a processor and a sensor system each communicatively coupled to each of the modular amenity units.

16. A powered modular dwelling frame, comprising:
an external frame configured to be coupled to a rigid enclosure, wherein the external frame includes frame members that define a plurality of receiving areas with respect to the rigid enclosure for receiving modular amenity units;
a powered rail integrated with the external frame and electrically connected to a power source for providing power to the modular amenity units; and
a connector configuration for physically and electrically coupling the modular amenity units at the plurality of receiving areas.

17. The powered modular dwelling frame of claim 16, wherein each of the plurality of receiving areas have a standard dimension.

18. The powered modular dwelling frame of claim 16, wherein each of the plurality of receiving areas is configured to engage with any one of the modular amenity units via the connector configuration.

19. The powered modular dwelling frame of claim 16, wherein the connector configuration includes a receiving connector positioned at a selectable location on the external frame and coupled to the powered rail.

20. The powered modular dwelling frame of claim 19, wherein the receiving connector is configured to engage with a mating connector of the modular amenity units thereby physically attaching each of the modular amenity units to the external frame and electrically coupling the each of the modular amenity units with the powered rail.
